(19) United States
(12) Patent Application Publication
(10) Pub. No.: US 2014/0138885 A1
(43) Pub. Date: May 22, 2014

(54) PNEUMATIC SPRING DEVICE

(71) Applicants: Continental Teves AG & Co. OHG, Frankfurt am Main (DE); Dr. Ing. h.c. F. Porsche AG, Stuttgart (DE)

(72) Inventors: Daniel MAY, Magstadt (DE); Richard Legierski, Boeblingen (DE); Ingo Tetzlaff, Barsinghausen (DE)

(73) Assignees: Continental Teves AG & Co. OHG, Frankfurt am Main (DE); Dr. Ing. h.c. F. Porsche AG, Stuttgart (DE)

(21) Appl. No.: 14/086,270

(22) Filed: Nov. 21, 2013

(30) Foreign Application Priority Data
Nov. 22, 2012 (DE) 10 2012 022 766.3

(51) Int. Cl. F16F 9/02; B60G 11/27

(52) U.S. Cl. CPC F16F 9/0218; B60G 11/27
USPC 267/64.11

(57) ABSTRACT

A pneumatic spring device with a housing (1) surrounding an air-filled annular chamber (2) and with a piston (3) sliding axially in the annular chamber (2), for the reduction or avoidance of flow noises, at least one cushion (K) made from metal wire netting being integrateable directly into the annular space (2) so as to be capable of throughflow.

### CROSS-REFERENCE TO RELATED APPLICATIONS

This application claims priority of German Patent Application No. 10 2012 022 766.3, filed Nov. 22, 2012, which is incorporated by reference herein in its entirety.

### FIELD OF INVENTION

The invention relates to a pneumatic spring device with a housing surrounding an air-filled annular chamber and with a piston sliding axially in the annular chamber.

### BACKGROUND

Suspensions with pneumatic springs which are tension-mounted between the chassis and body are employed as especially comfortable suspension elements, preferably in motor vehicles for use on roads. Just because such pneumatic spring devices are employed in especially comfortable vehicles, high functionality and maximum quality are required. One aspect which in this case is given a great degree of attention is the generation of noise in the load state. It is known from the prior art to use metal wire netting as damping elements—see, for example, EP 2 077 402 B1 and U.S. 2010/0314812 A1—or else for sound damping in flow Mufflers—see, for example, DE 25 23 289 A1.

### SUMMARY

The object on which the invention is based was, in a pneumatic spring device for motor vehicles, as far as possible to prevent the undesirable generation of noise during operation in as simple and as cost-effective a way as possible.

According to the invention, this object is achieved in that at least one cushion made from metal wire netting can be integrated directly into the annular space of a pneumatic spring device so as to be capable of having free throughflow.

In a preferred development of the invention, the metal wire netting may be woven or else knitted and be composed, for example, of high-grade steel wire.

In a very simple, but also highly effective version, the cushion made from metal wire netting may be introducible loosely into the annular space. It is also conceivable, however, that the cushion is fastened to the inner wall of the annular space at any location. For this purpose, the end closure caps are appropriate in a simple way as fastening locations for such cushions, also so as to make it easier to insert the cushion. In this case, cushions may be fastened at both end closure caps. It is likewise conceivable to provide cushions at a plurality of different locations within the annular space, for example even cushions with netting of different density or with different throughflow coefficients.

### BRIEF DESCRIPTION OF THE DRAWINGS

Features and advantages of the invention are explained in more detail in the following example description, with reference to the drawing in which:

FIG. 1 shows a diagrammatic illustration of a pneumatic suspension with locations where metal wire netting cushions according to the invention can be used;

FIG. 2 shows a cushion made from metal wire netting; and

FIG. 3 shows an exemplary possibility for fastening a cushion made from metal wire netting in the annular space of a pneumatic spring device.

### DETAILED DESCRIPTION

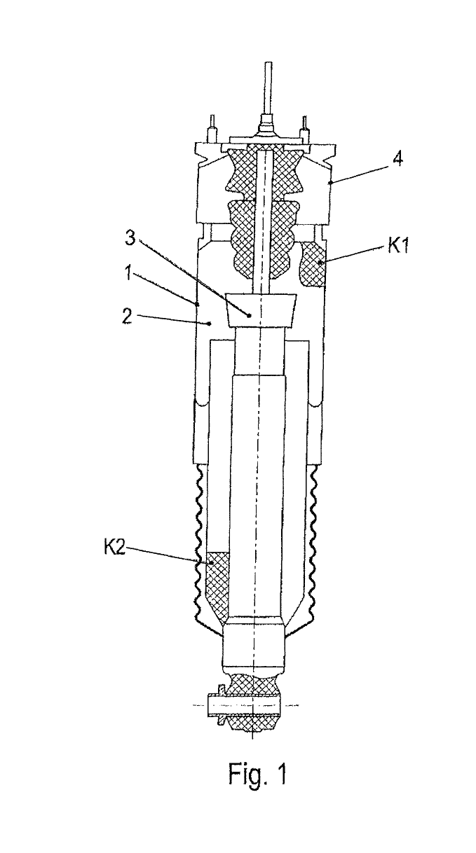

FIG. 1 shows diagrammatically a pneumatic spring device with a housing 1 which surrounds an annular chamber 2 filled with pressurized air. A piston 3 slides axially in the annular chamber 2. In order to damp the flow noises possibly occurring when the piston slides under load, there may be provision for integrating cushions K made from metal wire netting at various locations within the annular space 2—cushion K1 and cushion K2 are illustrated by way of example in FIG. 1.

The cushions K may be introduced loosely into the annular chamber 2; however, they may likewise be arranged at virtually any location and be fastened in any form. FIG. 3 shows such a fastening of the cushion K, for example to a closure cap 4 of the pneumatic spring device. For this purpose, a groove or concavity 5 by means of which the cushion K can be positioned and secured on stiffening struts or elevations 6 provided in the closure cap 4, is knitted in the metal wire netting of the cushion K.

The throughflow of the cushions K or their throughflow coefficient and therefore their action for the avoidance or reduction of flow noises can be preselectable by means of cushions K of different size or a different density of the metal wire netting.

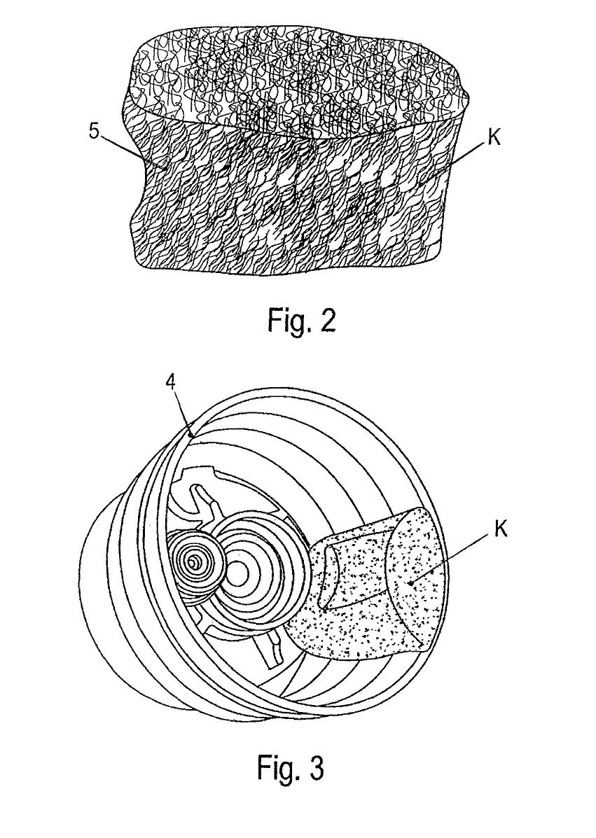

The cushions shown in FIGS. 1 to 3 are introduced partially on the circumference of the pneumatic spring. In contrast to this, it is also possible that the cushions are of annular form and then extend annularly on the circumference of the pneumatic spring.

### List of Reference Symbols

K Cushion
1 Housing
2 Annular chamber
3 Piston
4 Closure cap
5 Groove in closure cap
6 Stiffening strut in closure cap

What is claimed:

1. A pneumatic spring device with a housing (1) surrounding an air-filled annular chamber (2) and with a piston (3) sliding axially in the annular chamber (2), wherein, for the reduction or avoidance of flow noises, at least one cushion (K) made from metal wire netting is integrated directly into the annular chamber (2) so as to be capable of throughflow.

2. The pneumatic spring device as claimed in claim 1, wherein the or each cushion (K) is composed of woven metal wire netting.

3. The pneumatic spring device as claimed in claim 1, wherein the or each cushion (K) is composed of knitted metal wire netting.

4. The pneumatic spring device as claimed in claim 1, wherein the metal wire netting is composed of high-grade steel wire.

5. The pneumatic spring device as claimed in claim 1, wherein the or each cushion (K) is introducible loosely into the annular chamber (2).

6. The pneumatic spring device as claimed in claim 1, wherein the or each cushion (K) is fastenable to the inner wall of the annular chamber (2).

7. The pneumatic spring device as claimed in claim 6, wherein the or each cushion (K) is fastenable to a closure cap (4) in the inner space of the annular chamber (2).

8. The pneumatic spring device as claimed in claim 7, wherein the or each cushion (K) is fastenable to both end closure caps (4) of the annular chamber (2).

9. The pneumatic spring device as claimed in claim 1, wherein a plurality of cushions (K1, K2, etc.) are provided in an annular chamber (2).

10. The pneumatic spring device as claimed in claim 1, wherein the cushions (K, K1, K2, etc.) are composed of metal wire netting woven or knitted with different density.
